(19) United States
(12) Patent Application Publication
(10) Pub. No.: US 2017/0061355 A1
(43) Pub. Date: Mar. 2, 2017

(54) ELECTRONIC DEVICE AND METHOD

(71) Applicant: KABUSHIKI KAISHA TOSHIBA, Tokyo (JP)

(72) Inventor: Saori NAKAHARA, Ome Tokyo (JP)

(21) Appl. No.: 15/048,579

(22) Filed: Feb. 19, 2016

Related U.S. Application Data
(60) Provisional application No. 62/211,591, filed on Aug. 28, 2015.

(51) Int. Cl. G06Q 10/06; G06Q 10/10; H04L 29/08

(52) U.S. Cl. CPC G06Q 10/06398; H04L 67/10; G06Q 10/109; G06Q 10/107

(57) ABSTRACT

According to one embodiment, an electronic device includes a memory and a hardware processor. The hardware processor is configured to calculate a first amount of work. The hardware processor is configured to calculate a first threshold based on the first amount. The hardware processor is configured to compare a second amount of work performed on a first day and the calculated first threshold. If the second amount is less than the first threshold, the hardware processor is configured to determine that there is a tendency for work performance to decline. The hardware processor is configured to issue an alert in response to determining that there is the tendency for work performance to decline.

### CROSS-REFERENCE TO RELATED APPLICATIONS

This application claims the benefit of U.S. Provisional Application No. 62/211,591, filed Aug. 28, 2015, the entire contents of which are incorporated herein by reference.

### FIELD

Embodiments described herein relate generally to an electronic device and a method.

### BACKGROUND

In recent years, it has become important to appropriately manage employees' health in a company. As a method for managing physical health, a method for measuring the degree of physical fatigue of employees by working time, with the employees' working time used as an index, is conceivable. However, there has been a problem that the working time does not necessarily reflect the actual conditions (for example, busyness) of work, and it is hard to sufficiently manage physical health only by the working time. Also, regarding mental health, there has been a problem that a few indices for management exist, and it is hard even to take measurements like the above degree of fatigue.

Accordingly, the realization of a new technique for solving the above problems has been desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an example of a configuration of a work management system including an electronic device according to one embodiment.

FIG. 2 is a diagram showing an example of a data structure of work data in the embodiment.

FIG. 3 is a diagram showing an example of a data structure of average data in the embodiment.

FIG. 4 is a diagram showing an example of a data structure of threshold data in the embodiment.

FIG. 5 is a block diagram showing an example of a functional configuration of the electronic device in the embodiment.

FIG. 6 is a flowchart showing an example of a procedure for average calculation processing executed by the electronic device in the embodiment.

FIG. 7 is a flowchart showing an example of a procedure for threshold calculation processing executed by the electronic device in the embodiment.

FIG. 8 is a flowchart showing an example of a procedure for work performance determination processing executed by the electronic device in the embodiment.

### DETAILED DESCRIPTION

Various embodiments will be described hereinafter with reference to the accompanying drawings.

In general, according to one embodiment, an electronic device includes a memory and a hardware processor in communication with the memory. The hardware processor is configured to acquire work data indicating an amount of work performed during a first period. The hardware processor is configured to calculate a first amount of work based on the acquired work data. The hardware processor is configured to calculate a first threshold based on the first amount, the first threshold being an index for determining a degree of work performance. The hardware processor is configured to compare a second amount of work performed on a first day and the calculated first threshold. If the second amount is less than the first threshold, the hardware processor is configured to determine that there is a tendency for work performance to decline. The hardware processor is configured to issue an alert in response to determining that there is the tendency for work performance to decline.

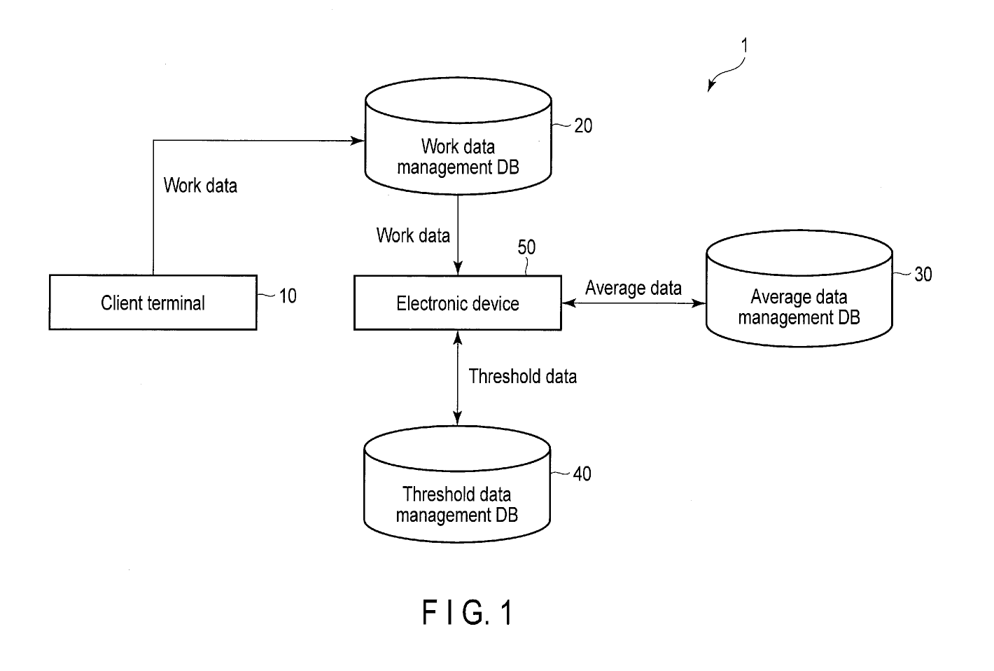

FIG. 1 is a block diagram showing an example of a configuration of a work management system including an electronic device according to an embodiment. A work management system 1 shown in FIG. 1 includes at least one client terminal 10, a work data management database (hereinafter, referred to as a work data management DB) 20, an average data management database (hereinafter, referred to as an average data management DB) 30, a threshold data management database (hereinafter, referred to as a threshold data management DB) 40, and an electronic device 50. The electronic device 50 included in the work management system 1 is connected to the client terminal 10 and various databases 20 to 40 so that they can communicate with each other. Hereinafter, various devices 10 to 50 included in the work management system 1 will be described in order. It should be noted that although FIG. 1 illustrates the case where the number of one client terminals 10 is one, a plurality of client terminals 10 may be provided.

The client terminal 10 is, for example, a personal computer (PC) or a tablet terminal. It should be noted that the present embodiment will be described, assuming the case where the client terminal 10 is a PC. In addition, it is assumed that an application which can manage schedules, for example, the time and date of a meeting, is installed in advance in the client terminal 10. Moreover, it is assumed that an application which can transmit and receive emails is installed in advance in the client terminal 10. Furthermore, it is assumed that a unified communication (UC) tool that can manage a call history showing how long and whom an operator of the client terminal 10 telephoned and can report whether a desired person is able to speak is installed in advance in the client terminal 10.

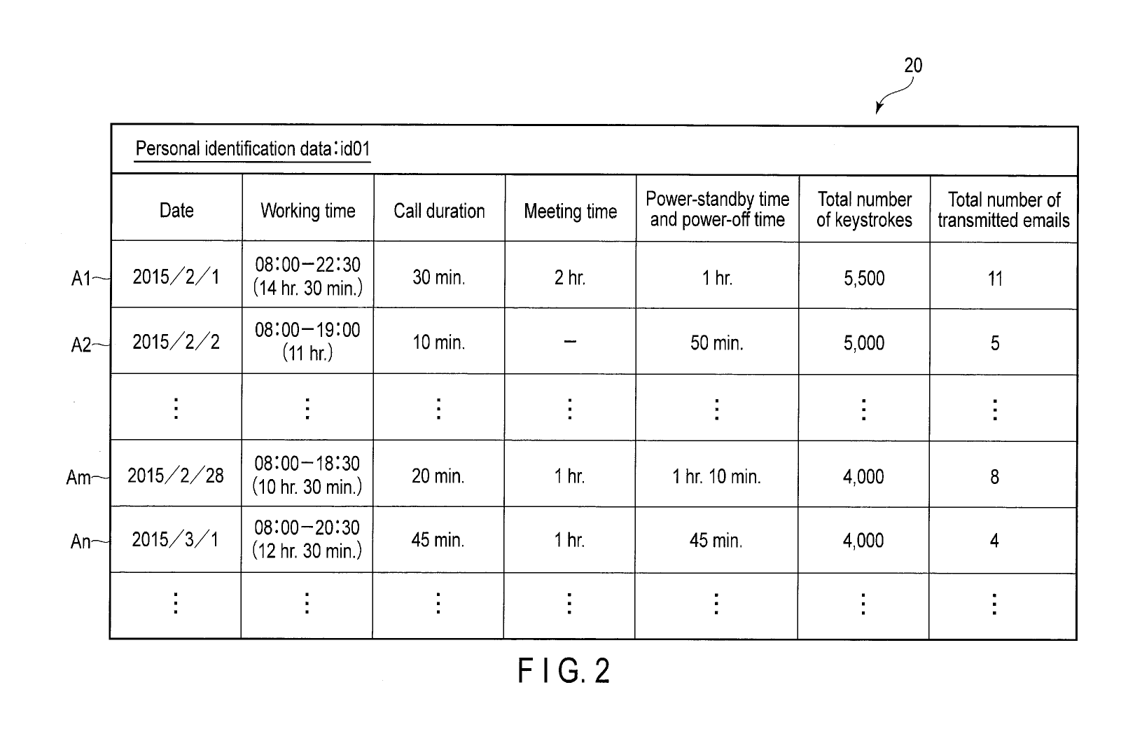

The work data management DB 20 is a storage unit in which work data indicating the amount of work performed by the operator operating the client terminal 10 on a predetermined day is stored. The work data will be herein described in more detail with reference to FIG. 2. FIG. 2 is a diagram showing an example of a data structure of the work data. The work data is, for example, data in which a date, a working time, call duration, a meeting time, a power-standby time and power-off time, the total number of keystrokes, the total number of transmitted emails, etc., are associated with each other for each personal identification data item. In addition, the work data may further includes, for example, items such as a use time (specifically, a use time in the foreground of a screen) of each application installed in the client terminal 10, and an overtime, as well as the above-described various items.

Personal identification data is identification data for identifying the operator of the client terminal 10. The personal identification data may be, for example, the name of the operator of the client terminal 10. The working time indicates times when the operator of the client terminal 10 arrives at the office and leaves the office on the associated date. The call duration indicates a time used to telephone others during the associated working time. The meeting time indicates a time used to attend a meeting during the associated working time. The power-standby time and power-off time indicates the sum of a time for which the client terminal 10 was in a standby state and a time for which the client terminal 10 was powered off during the associated working time. The total number of keystrokes indicates the number of times a keyboard was pressed by the operator of the client terminal 10 during the associated working time. It should be noted that if the client terminal 10 is a tablet terminal, the item of the total number of keystrokes may be replaced by the total number of flicks, the total number of taps, etc. Moreover, the total number of emails indicates the number of emails transmitted by the operator of the client terminal 10 during the associated working time. It should be noted that each value included in the work data is collected as appropriate from the client terminal 10, an attendance manager, which is not shown in the figures and can manage attendance, etc.

For example, according to a work data item A1 shown in FIG. 2, it is indicated that the working time on Feb. 1, 2015, of the operator of the client terminal 10 identified by personal identification data “id01” is 14 hours and 30 minutes from 8:00 to 22:30, the call duration is 30 minutes, the meeting time is 2 hours, the power-standby time and power-off time is an hour, the total number of keystrokes is 5,500, and the total number of transmitted emails is 11. Although the work data item A1 has been herein explained as an example, the same is true of other work data items A2, Am, and An shown in FIG. 2, and thus, a detailed explanation thereof is omitted herein.

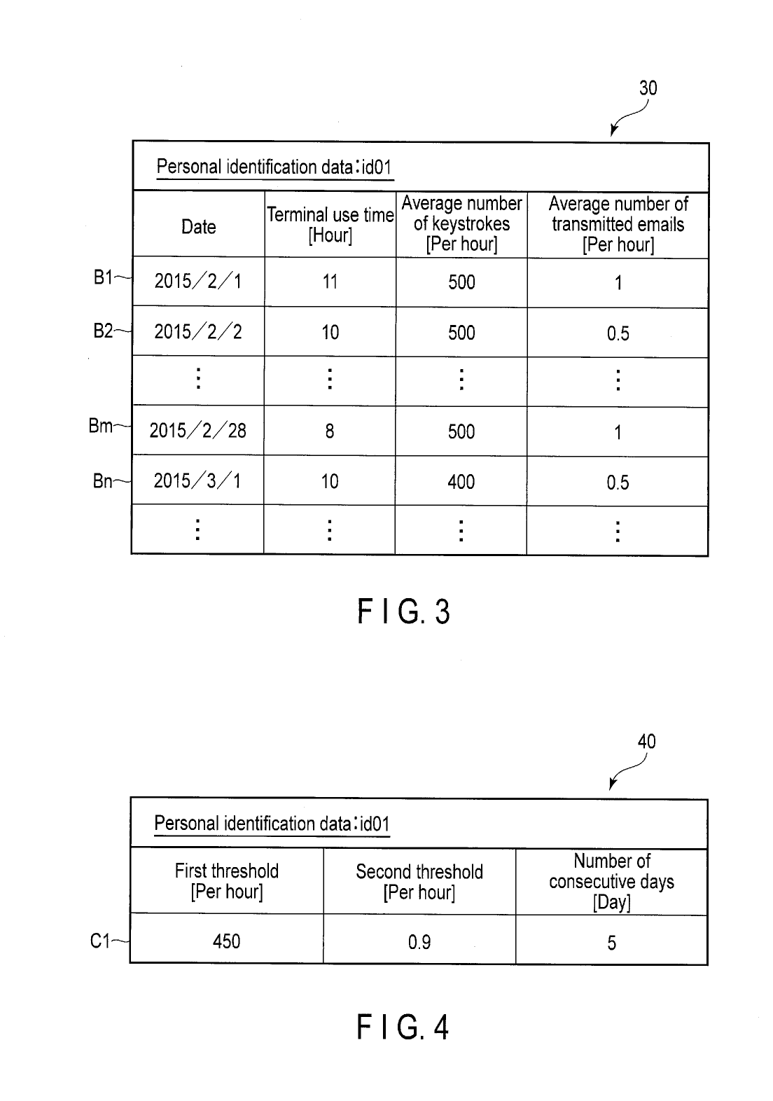

The average data management DB 30 is a storage unit in which average data indicating at least the number of keystrokes per unit time and the number of transmitted emails per unit time is stored. The average data will be herein described in more detail with reference to FIG. 3. FIG. 3 is a diagram showing an example of a data structure of the average data. The average data is, for example, data in which a date, a terminal use time, the average number of keystrokes, and the average number of transmitted emails are associated with each other for each personal identification data item.

The terminal use time indicates a time obtained by subtracting the sum of call duration, a meeting time, and a power-standby time and power-off time on an associated date from a working time on the associated date. That is, the terminal use time indicates a time for which the operator of the client terminal 10 is presumed to be actually operating the client terminal 10. The average number of keystrokes is calculated by dividing the above-described total number of keystrokes by the terminal use time, and indicates the number of keystrokes per unit time on the associated date. The average number of transmitted emails is calculated by dividing the above-described total number of transmitted emails by the terminal use time, and indicates the number of emails transmitted per unit time on the associated date. It should be noted that each value included in the average data is calculated by the electronic device 50, which will be described later, and is recorded as appropriate by the electronic device 50.

For example, according to an average data item 31 shown in FIG. 3, it is indicated that the terminal use time on Feb. 1, 2015 of the operator of the client terminal 10 identified by the personal identification data “id01” is 11 hours, the average number of keystrokes is 500, and the average number of transmitted emails is 1. Although the average data item 31 has been herein explained as an example, the same is true of other average data items 32, Bm, and Bn shown in FIG. 3, and thus, a detailed explanation thereof is omitted herein.

The threshold data management DB 40 is a storage unit in which threshold data indicating at least a threshold used to determine the degree of work performance of the operator operating the client terminal 10 is stored. The threshold data will be herein described in more detail with reference to FIG. 4. FIG. 4 is a diagram showing an example of a data structure of the threshold data. The threshold data is, for example, data in which a first threshold related to the average number of keystrokes, a second threshold related to the average number of transmitted emails, and the number of consecutive days are associated with each other for each personal identification data item.

The first threshold is a threshold set for the average number of keystrokes, and is a value used to determine the degree of work performance in the electronic device 50, which will be described later. The second threshold is a threshold set for the average number of transmitted emails, and is a value used to determine the degree of work performance in the electronic device 50, which will be described later. The number of consecutive days is the number of consecutive days on each of which it is determined that there is a decline in work performance, and is defined as the number which permits an alert to be issued to the operator of the client terminal 10 or a responsible person for a section to which the operator belongs. It should be noted that each value included in the threshold data is calculated by the electronic device 50, which will be described later, and is recorded as appropriate by the electronic device 50.

For example, according to a threshold data item C1 shown in FIG. 4, it is indicated that the first threshold for the operator of the client terminal 10 identified by the personal identification data “id01” is 450, the second threshold is 0.9, and the number of consecutive days is 5. That is, according to the threshold data item C1, it is provided that if a state in which the number of keystrokes per unit time is less than 450 and the number of emails transmitted per unit time is less than 0.9 continues 5 days, an alert is issued.

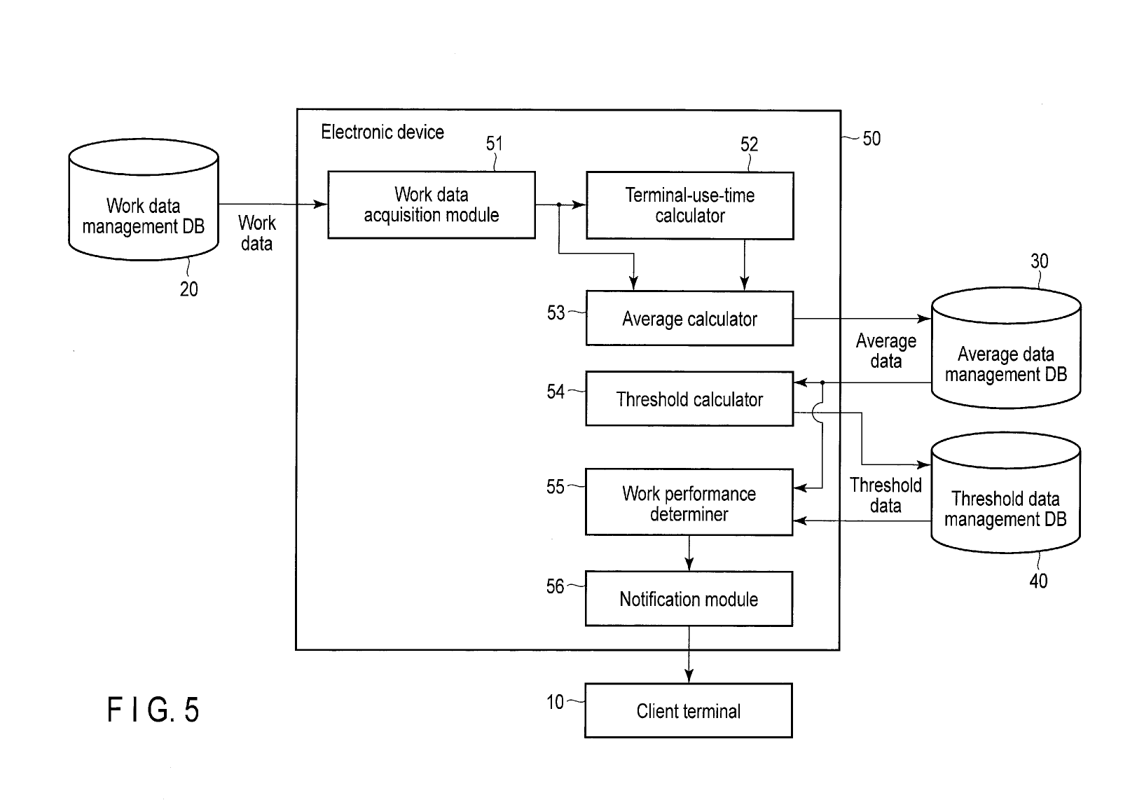

The electronic device 50 has the function of determining the degree of the work performance of the operator of the client terminal 10, and if there is a tendency for the work performance to decline, issuing an alert as there may be a health problem. The electronic device 50 will be hereinafter described in more detail with reference to FIG. 5. To determine the degree of the work performance of the operator of the client terminal 10, the electronic device 50 calculates a first threshold and a second threshold based on average data calculated (collected) during a predetermined period, for example, one month. And, the electronic device 50 determines the degree of work performance based on the calculated first threshold and second threshold. That is, in the following description, it is assumed that there are two periods, a collection period during which data is collected to calculate the first threshold and the second threshold and a determination period during which the degree of work performance is actually determined.

FIG. 5 is a block diagram showing an example of a functional configuration of the electronic device 50. The electronic device 50 shown in FIG. 5 includes a work data acquisition module 51, a terminal-use-time calculator 52, an average calculator 53, a threshold calculator 54, a work performance determiner 55, a notification module 56, etc.

The work data acquisition module 51 has the function of acquiring work data stored in the work data management DB 20. Acquired work data is transmitted to the terminal-use-time calculator 52 and the average calculator 53.

Upon receiving input of work data transmitted from the work data acquisition module 51, the terminal-use-time calculator 52 performs a process of subtracting the sum of call duration, a meeting time, and a power-standby time and power-off time from a working time indicated by the work data of the received input. The terminal-use-time calculator 52 thereby can calculate a terminal use time for which the operator operating the client terminal 10 is presumed to be actually using the client terminal 10. Terminal-use-time data indicating the calculated terminal use time is transmitted to the average calculator 53.

The average calculator 53 has the function of receiving input of work data transmitted from the work data acquisition module 51 and receiving input of terminal-use-time data transmitted from the terminal-use-time calculator 52. In addition, the average calculator 53 performs a process of dividing the total number of keystrokes included in the work data of the received input by a terminal use time indicated by the terminal-use-time data of the received input. Moreover, the average calculator 53 performs a process of dividing the total number of transmitted emails included in the work data of the received input by the terminal use time indicated by the terminal-use-time data of the received input. The average calculator 53 thereby can calculate the number of keystrokes per unit time of the operator operating the client terminal 10 (the average number of keystrokes) and the number of emails transmitted per unit time by the operator (the average number of transmitted emails). Average data in which the calculated average number of keystrokes, the calculated average number of transmitted emails, and the terminal use time used to calculate these numbers are associated with each other is recorded as appropriate in the average data management DB 30 for each personal identification data item.

At a point in time when a preset collection period ends, the threshold calculator 54 acquires one or more average data items stored in the average data management DB 30. In addition, the threshold calculator 54 performs a process of dividing the sum of the average numbers of keystrokes indicated by the acquired one or more average data items by the number of acquired average data items (in other words, the number of days during the collection period). Moreover, the threshold calculator 54 performs a process of dividing the sum of the average numbers of transmitted emails indicated by the acquired one or more average data items by the number of acquired average data items. The threshold calculator 54 thereby can calculate the number of keystrokes per unit time of the operator operating the client terminal 10 and the number of emails presumed to be transmitted per unit time by the operator during the whole collection period. Although the threshold calculator 54 herein performs a process of calculating the average number of keystrokes and the average number of transmitted emails during the whole collection period at a point in time when the preset collection period ends, the process is not necessarily performed with this timing, but may be performed, for example, every time new average data is stored in the average data management DB 30.

Upon calculating the average number of keystrokes and the average number of transmitted emails during the whole collection period, the threshold calculator 54 calculates a first threshold by multiplying the average number of keystrokes by a preset value (which is less than one). Similarly, the threshold calculator 54 calculates a second threshold by multiplying the average number of transmitted emails during the whole collection period by a preset value (which is less than one). The value by which the average number of keystrokes is multiplied to calculate the first threshold and the value by which the average number of transmitted emails is multiplied to calculate the second threshold may be the same value or different values. Threshold data in which the calculated first threshold, the calculated second threshold, and the number of consecutive days set arbitrarily are associated with each other is recorded as appropriate in the threshold data management DB 40 for each personal identification data item.

The work performance determiner 55 acquires average data of a date for which the degree of work performance is determined from the average data management DB 30, when the collection period ends and the determination period starts regarding predetermined personal identification data. Specifically, the work performance determiner 55 acquires average data of the day before from the next day of the start day of the determination period. Upon acquiring average data regarding the predetermined personal identification data, the work performance determiner 55 acquires threshold data regarding the personal identification data from the threshold data management DB 40.

The work performance determiner 55 performs a first determination process of comparing the average number of keystrokes included in the acquired average data and a first threshold indicated by the acquired threshold data, and determining whether the average number of keystrokes is less than the first threshold. Similarly, the work performance determiner 55 performs a second determination process of comparing the average number of transmitted emails included in the acquired average data and a second threshold indicated by the acquired threshold data, and determining whether the average number of transmitted emails is less than the second threshold.

If the average number of keystrokes is less than the first threshold as a result of the above-described first determination process and the average number of transmitted emails is less than the second threshold as a result of the above-described second determination process, the work performance determiner 55 determines (presumes) that there is a tendency for the work performance of the operator identified by the predetermined personal identification data to decline. At this time, the work performance determiner 55 adds one to a consecutive-day counter not shown in the figures. The consecutive-day counter indicates how many consecutive days there is a tendency for work performance to decline, and adds one if there is a tendency for work performance to decline, and is reset to zero if there is no tendency for work performance to decline. In the present embodiment, the case where it is determined that there is a tendency for work performance to decline, if it is determined that the average numbers are less than the thresholds (the first threshold and the second threshold) in both the first and second determination processes has been described. However, for example, it may be determined that there is a tendency for work performance to decline, if it is determined that the average number is less than a threshold in one of the determination processes.

If it is determined that there is a tendency for the work performance of the operator to decline, the work performance determiner 55 determines whether the value of the consecutive-day counter not shown in the figures exceeds the number of consecutive days included in the acquired threshold data (or whether the value of the consecutive-day counter is greater than or equal to the number of consecutive days included in the threshold data). If it is determined that the value of the consecutive-day counter exceeds the number of consecutive days included in the threshold data as a result of this determination, the work performance determiner 55 presumes that the operator of the client terminal 10 may have a health problem. Also, the work performance determiner 55 performs a process of instructing the notification module 56 to issue an alert.

The notification module 56 has the function of issuing an alert to a preset person (for example, the operator of the client terminal 10 who may have a health problem or a responsible person for the operator) in accordance with an instruction from the work performance determiner 55. FIG. 5 illustrates the case where an alert from the notification module 56 is issued to the client terminal 10. However, for example, an alert may be issued to an administrative terminal not shown in the figures, which is operated by the responsible person for the operator of the client terminal 10, as described above. In addition, as an issuing method of an alert, a specific sound may be made through the client terminal 10, etc., or a message reporting that there may be a health problem, etc., may be displayed on a screen of the client terminal 10, etc. Moreover, if an alert is issued, additional data indicating, for example, the name of a file created or edited by an application used at work, a search keyword frequently used by an application used at work, the title of a transmitted email, and the title of a meeting he or she attended, may be displayed on the screen.

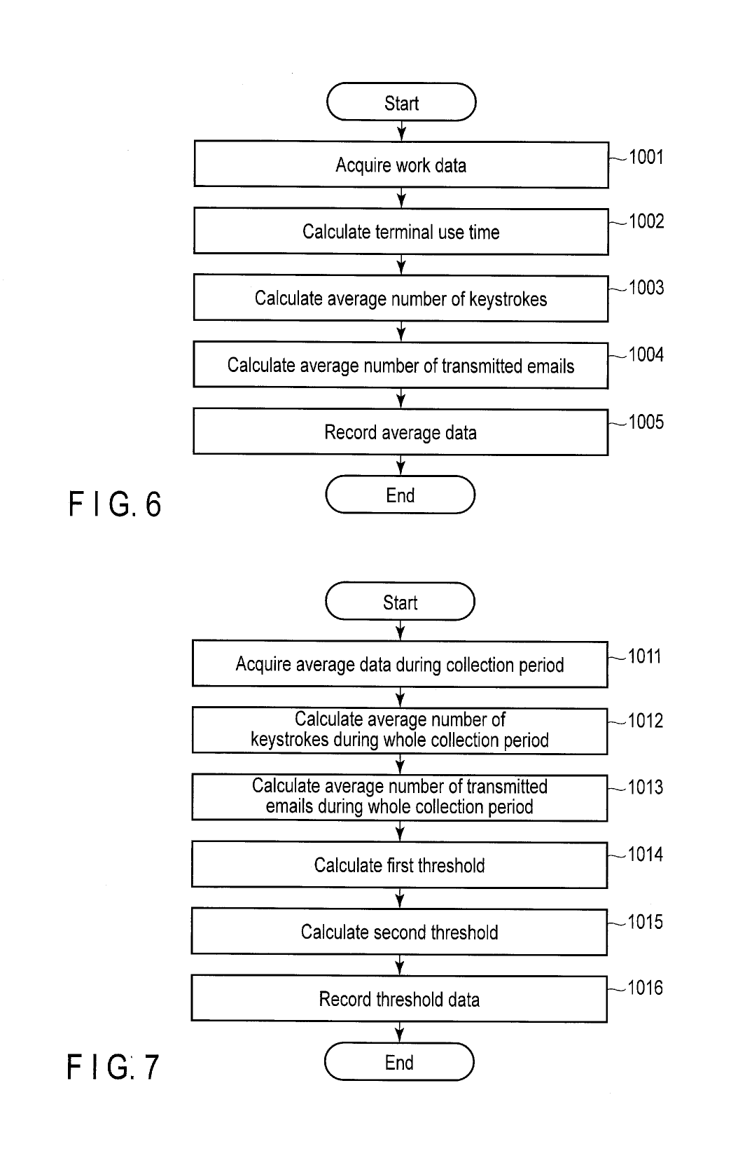

A procedure for average calculation processing executed by the electronic device 50 having the above-described configuration will be next described with reference to the flowchart of FIG. 6.

First, the work data acquisition module 51 acquires work data including personal identification data for identifying the operator of the client terminal 10 whose degree of work performance is to be determined from the work data management DB 20 (block 1001). Hereinafter, a specific example is also described, assuming the case where the work data item A1 shown in FIG. 2 has been acquired by the work data acquisition module 51. It should be noted that acquired work data is transmitted to each of the terminal-use-time calculator 52 and the average calculator 53.

Then, upon receiving input of work data transmitted from the work data acquisition module 51, the terminal-use-time calculator 52 subtracts the sum of call duration, a meeting time, and a power-standby time and power-off time from a working time included in the work data of the received input, thereby calculating a terminal use time (block 1002). If the work data item A1 has been acquired by the work data acquisition module 51 as described above, the terminal-use-time calculator 52 calculates the value “11 hours” as a terminal use time by subtracting “3 hours and 30 minutes”, which is the sum of the call duration “30 minutes”, the meeting time “2 hours”, and the power-standby time and power-off time “one hour” from the working time “14 hours and 30 minutes” included in the work data item A1. Terminal-use-time data indicating the calculated terminal use time is transmitted to the average calculator 53.

Next, upon receiving input of work data transmitted from the work data acquisition module 51 and terminal-use-time data transmitted from the terminal-use-time calculator 52, the average calculator 53 divides the total number of keystrokes included in the work data of the received input by the terminal use time indicated by the terminal-use-time data of the received input, thereby calculating the average number of keystrokes (block 1003). Specifically, the average calculator 53 calculates the value “500” as the average number of keystrokes by dividing the total number of keystrokes “5,500” included in the work data item A1 by the terminal use time “11 hours” calculated by the terminal-use-time calculator 52.

Moreover, the average calculator 53 divides the total number of transmitted emails included in the work data of the received input by the terminal use time indicated by the terminal-use-time data of the received input, thereby calculating the average number of transmitted emails (block 1004). Specifically, the average calculator 53 calculates the value “one” as the average number of transmitted emails by dividing the total number of emails “11” included in the work data item A1 by the terminal use time “11 hours” calculated by the terminal-use-time calculator 52.

Then, the average calculator 53 records a date included in the work data of the received input, the terminal use time indicated by the terminal-use-time data of the received input, the calculated average number of keystrokes, and the calculated average number of transmitted emails, associating them with each other, in the average data management DB 30, as average data on the operator of the client terminal 10 whose degree of work performance is to be determined (block 1005), and ends the processes herein. Specifically, the average calculator 53 records the average data item B1 in the average data management DB 30, and ends the processes herein. The electronic device 50 repeatedly performs the above-described processes of blocks 1001 to 1005 every day.

A procedure for threshold calculation processing executed by the electronic device 50 at a point in time when a collection period ends will be next described with reference to the flowchart of FIG. 7.

First, regarding the operator of the client terminal 10 whose degree of work performance is to be determined, the threshold calculator 54 acquires all of one or more average data items recorded in the average data management DB 30 during the collection period (block 1011). For example, if the personal identification data on the operator of the client terminal 10 whose degree of work performance is to be determined is “id01”, the collection period is Feb. 1 to 28, 2015, and a determination period begins on Mar. 1, 2015, the threshold calculator 54 acquires average data items B1, B2, . . . , Bm of the one or more average data items shown in FIG. 3 from the average data management DB 30.

Then, the threshold calculator 54 divides the sum of the respective average numbers of keystrokes included in the acquired one or more average data items by the number of acquired average data items, thereby calculating the average number of keystrokes during the whole collection period (block 1012). In addition, the threshold calculator 54 divides the sum of the respective average numbers of transmitted emails included in the acquired one or more average data items by the number of acquired average data items, thereby calculating the average number of transmitted emails during the whole collection period (block 1013).

The threshold calculator 54 multiplies the calculated average number of keystrokes during the whole collection period by a predetermined value that is preset, thereby calculating a first threshold (block 1014). In addition, the threshold calculator 54 multiplies the calculated average number of transmitted emails during the whole collection period by a predetermined value that is preset, thereby calculating a second threshold (block 1015).

Then, the threshold calculator 54 records the calculated first threshold, the calculated second threshold, and the number of consecutive days that is preset, associating them with each other, in the threshold data management DB 40 as threshold data on the operator of the client terminal 10 whose degree of work performance is to be determined (block 1016), ends the processes herein. The number of consecutive days is a value which can be arbitrarily set by the operator of the electronic device 50, and is preset.

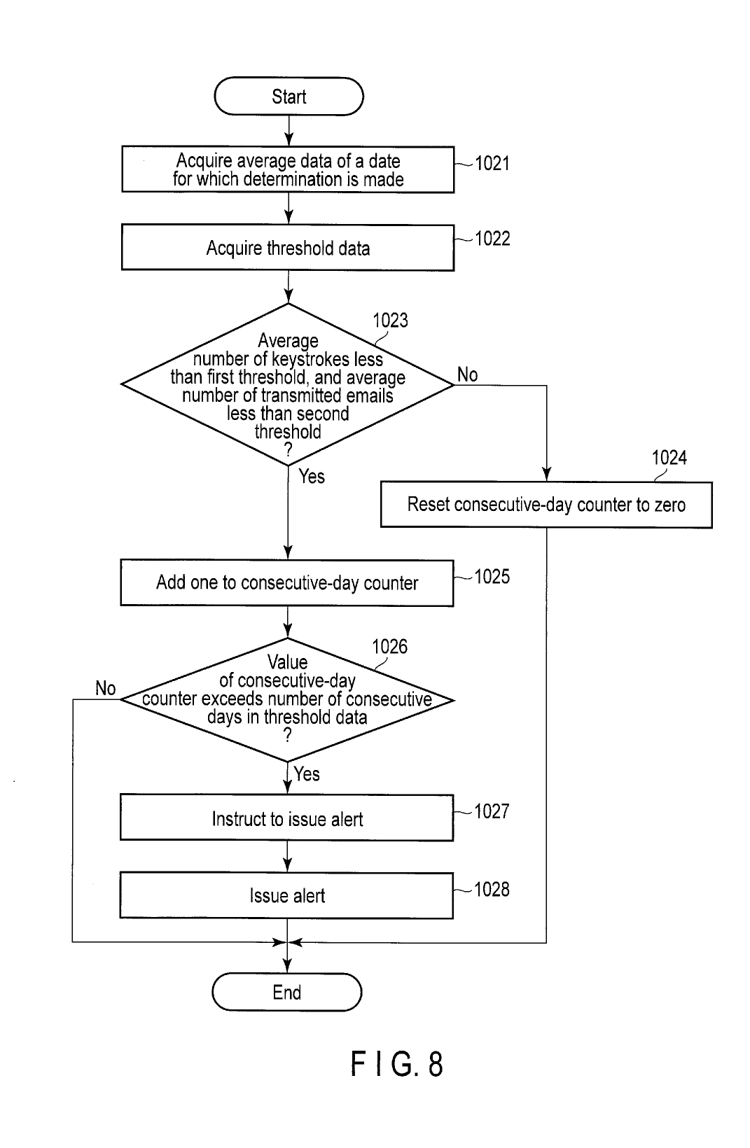

A procedure for work performance determination processing executed by the electronic device 50 during the determination period will be next described with reference to the flowchart of FIG. 8.

First, the work performance determiner 55 acquires average data of a date whose degree of work performance is to be determined, which is average data on the operator of the client terminal 10 whose degree of work performance is to be determined, from the average data management DB 30 (block 1021). Hereinafter, a specific example is also described, assuming the case where the collection period is Feb. 1 to 28, 2015, the determination period begins on Mar. 1, 2015, and the average data item Bn shown in FIG. 3 has been acquired by the work performance determiner 55 as average data of the date (March 1) whose degree of work performance is to be determined.

Then, the work performance determiner 55 acquires threshold data on the operator of the client terminal 10 whose degree of work performance is to be determined from the threshold data management DB 40 (block 1022). If the average data item Bn has been acquired as described above, the work performance determiner 55 acquires the threshold data item C1 shown in FIG. 4 as threshold data on the personal identification data “id01” included in the average data item Bn.

Next, the work performance determiner 55 determines whether the average number of keystrokes indicated by the acquired average data is less than a first threshold indicated by the acquired threshold data. Also, the work performance determiner 55 determines whether the average number of transmitted emails indicated by the acquired average data is less than a second threshold indicated by the acquired threshold data (block 1023). Specifically, the work performance determiner 55 determines whether the average number of keystrokes is less than the first threshold by comparing the average number of keystrokes “400” indicated by the average data item En and the first threshold “450” indicated by the threshold data item C1. Also, the work performance determiner 55 determines whether the average number of transmitted emails is less than the second threshold, by comparing the average number of transmitted emails “0.5” indicated by the average data item En and the second threshold “0.9” indicated by the threshold data item C1. In this specific example, both the average number of keystrokes and the average number of transmitted emails are less than the thresholds, and thus, the flow proceeds to the process of block 1025, which will be described later.

If it is determined the one or both of the average number of keystrokes and the average number of transmitted emails are not less than the thresholds as a result of the determination in block 1023 (No in block 1023), the work performance determiner 55 resets the value of the consecutive-day counter to zero as there is no tendency for the work performance of the operator of the client terminal 10 to decline (block 1024), and ends the processes herein.

On the other hand, if it is determined that both the average number of keystrokes and the average number of transmitted emails are less than the thresholds as a result of the determination in block 1023 (Yes in block 1023), the work performance determiner 55 adds one to the value of the consecutive-day counter as there is a tendency for the work performance of the operator of the client terminal 10 to decline (block 1025). As described above, in this specific example, it is assumed that the degree of the work performance on Mar. 1, 2015, which is the start day of the determination period, is determined. Therefore, the value of the consecutive-day counter is zero before the processing, and the value of the consecutive-day counter becomes one through the processing.

Then, the work performance determiner 55 determines whether the value of the consecutive-day counter exceeds the number of consecutive days included in the acquired threshold data (block 1026). Specifically, the work performance determiner 55 determines whether the value of the consecutive-day counter exceeds the number of consecutive days included in the threshold data by comparing “1” of the consecutive-day counter and “5” of the number of consecutive days indicated by the threshold data item C1. If it is determined that the value of the consecutive-day counter does not exceed the number of consecutive days included in the threshold data as in this specific example (No in block 1026), the work performance determiner 55 ends the processes herein.

On the other hand, if it is determined that the value of the consecutive-day counter exceeds the number of consecutive days included in the threshold data as a result of the determination in block 1026 (Yes in block 1026), the work performance determiner 55 presumes that the operator of the client terminal 10 may have a health problem. And, the work performance determiner 55 instructs the notification module 56 to issue an alert (block 1027).

Then, the notification module 56 issues an alert to the effect that the operator of the client terminal 10 may have a health problem to a terminal operated by a preset person in accordance with an instruction from the work performance determiner 55 (block 1028), and ends the processes herein.

In the present embodiment, the case where the personal average work performance is calculated, and a threshold based thereon is set individually has been described. However, for example, the average work performance per section may be calculated, so that a threshold based thereon is set per section. It thereby suffices that a threshold is not set individually but is set per section, that is, the number of times a threshold is calculated can be reduced. Accordingly, a load on the threshold calculator 54 can be lightened.

In addition, whether there may be a health problem (for example, overwork) may be determined from other aspects by presetting a third threshold related to the total number of keystrokes of one day and a fourth threshold related to the total number of transmitted emails of one day. Specifically, if a state in which the total number of keystrokes of one day is greater than or equal to the preset third threshold and the total number of transmitted emails of one day is greater than or equal to the preset fourth threshold continues beyond the preset number of consecutive days, an alert may be issued as there may be a health problem. It thereby can be determined from multiple aspects whether there is a health problem, and thus, an advantage that convenience is more increased can be obtained.

Moreover, the electronic device 50 according to the present embodiment may be used not only to determine whether there may be a health problem but also to appraise work performance, for example.

It should be noted that some or all of the work data acquisition module 51, the terminal-use-time calculator 52, the average calculator 53, the threshold calculator 54, the work performance determiner 55, and the notification module 56 included in the electronic device 50 may be implemented, for example, by causing a hardware processor such as a CPU in the client terminal 10 to execute a program, that is, may be implemented as software, may be implemented as hardware such as an IC, or may be implemented by using software and hardware together.

According to the above-described one embodiment, the electronic device 50 has the structure in which the average work performance is calculated, and if subsequent work performance continues to be remarkably lower than the calculated average performance, an alert is issued. Therefore, a tendency for work performance to decline which is shown if there is a health problem can be immediately noticed. This makes it possible to appropriately manage employees' health, for example, to handle employees who may have a health problem by making them take a vacation, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a memory; and
a hardware processor in communication with the memory, the hardware processor configured to:
acquire work data indicating an amount of work performed during a first period;
calculate a first amount of work based on the acquired work data;
calculate a first threshold based on the first amount, the first threshold being an index for determining a degree of work performance;
compare a second amount of work performed on a first day and the calculated first threshold;
if the second amount is less than the first threshold, determine that there is a tendency for work performance to decline; and
issue an alert in response to determining that there is the tendency for work performance to decline.

2. The electronic device of claim 1, wherein the first amount is an average per unit time of the amount of work performed during the first period.

3. The electronic device of claim 1, wherein the hardware processor is configured to acquire, from a client terminal, the work data indicating at least a first number of keystrokes and a second number of transmitted emails, the first number of keystrokes indicating a number of times a keyboard provided in the client terminal is pressed, the second number of transmitted emails indicating a number of emails transmitted from the client terminal.

4. The electronic device of claim 3, wherein the hardware processor is configured to:
calculate a terminal use time for the client terminal, and
calculate each of an average of the first number and an average of the second number as the first amount, by dividing each of the first number and the second number indicated by the work data by the calculated terminal use time.

5. The electronic device of claim 4, wherein the work data further indicates a working time, call duration indicating a time used to telephone during the working time, a meeting time indicating a time used to attend a meeting during the working time, and a power standby/off time indicating a time for which the client terminal is in a power-standby state or a power-off state during the working time, and
the terminal use time is calculated by subtracting the sum of the call duration, the meeting time, and the power standby/off time indicated by the work data from the working time indicated by the work data.

6. The electronic device of claim 2, wherein the hardware processor is configured to calculate the first threshold by multiplying the calculated average by a first value which is preset and is less than one.

7. The electronic device of claim 1, wherein the hardware processor is configured to issue the alert in response to consecutively determining a third number of times that there is the tendency for work performance to decline.

8. The electronic device of claim 3, wherein the hardware processor is configured to issue the alert to the client terminal.

9. The electronic device of claim 3, wherein the hardware processor is configured to issue the alert to an administrative terminal operated by an administrator of an operator of the client terminal.

10. The electronic device of claim 2, wherein the hardware processor is further configured to:
calculate a second threshold by multiplying the calculated average by a first value which is preset and is greater than one, the second threshold being an index for determining the degree of work performance and differing from the first threshold;
compare the second amount and the calculated second threshold;
if the second amount exceeds the second threshold, determine that excessive work is performed; and
issue the alert in response to determining that excessive work is performed.

11. The electronic device of claim 1, wherein the hardware processor comprising means for:
acquiring the work data;
calculating the first amount based on the acquired work data;
calculating the first threshold based on the first amount;
comparing the second amount and the calculated first threshold;
if the second amount is less than the first threshold, determining that there is the tendency for work performance to decline; and
issuing the alert in response to determining that there is the tendency for work performance to decline.

12. A method comprising:
acquiring work data indicating an amount of work performed during a first period;
calculating a first amount of work based on the acquired work data;
calculating a first threshold based on the first amount, the first threshold being an index for determining a degree of work performance;
comparing a second amount of work performed on a first day and the calculated first threshold;
if the second amount is less than the first threshold, determining that there is a tendency for work performance to decline; and
issuing an alert in response to determining that there is the tendency for work performance to decline.
